(19) United States
(12) Patent Application Publication
(10) Pub. No.: US 2026/0176922 A1
(43) Pub. Date: Jun. 25, 2026

(54) CLOSED LOOP GEOTHERMAL SYSTEM AND METHOD

(71) Applicant: Schlumberger Technology Corporation, Sugar Land, TX (US)

(72) Inventors: Benoit Deville, Sugar Land, TX (US); Sarah Patterson, Cambridge (GB); Shunfeng Zheng, Sugar Land, TX (US); Pedro Daniel Rangel Escarra, Dubai (AE); Andrey Aleksyuk, Cambridge (GB)

(21) Appl. No.: 19/428,702

(22) Filed: Dec. 22, 2025

Related U.S. Application Data
(60) Provisional application No. 63/737,951, filed on Dec. 23, 2024.

(51) Int. Cl. E21B 7/04; E21B 7/15; E21B 17/20; F24T 10/00; F24T 10/10

(52) U.S. Cl. CPC E21B 7/04; E21B 17/20; F24T 10/10; E21B 7/15; F24T 2010/53

(57) ABSTRACT

Embodiments presented provide for a system and method for heat extraction from geological stratum. In some aspects, a closed loop system is used to efficiently remove heat from marginal heat bearing stratum thereby allowing power production facilities to be located in expanded world-wide sitings.

### CROSS-REFERENCE TO RELATED APPLICATIONS

This patent application claims benefit of U.S. Provisional Patent Application Ser. No. 63/737951 filed Dec. 23, 2024, which is entirely incorporated herein by reference.

### FIELD OF THE DISCLOSURE

Aspects of the disclosure relate to geothermal engineering systems. More specifically, aspects of the disclosure relate to a closed loop geothermal heat extraction process and method.

### BACKGROUND

Geothermal heat extraction is an innovative approach to harnessing the Earth's natural heat for various beneficial activities, primarily energy production. Heat is often present in rock formations in certain areas of the world, making these regions prime candidates for geothermal energy projects. Few conventional systems are currently equipped to handle heat extraction on a large and cost-efficient basis. The inherent challenges associated with these systems make it difficult to exploit geothermal resources effectively.

One of the primary challenges in geothermal heat extraction is the thermal conductivity of rock. Rock, in general, is a poor thermal conductor, which precludes the use of conventional extraction techniques. To obtain large quantities of heat from a geological stratum, there must be a substantial amount of accessible rock, and the surface area of the rock must be significant to allow for an effective heat exchange process. This requirement makes it essential to identify geological formations with a large surface area and high heat retention capacity.

The presence of heat can be deleterious to the removal of oil and gas deposits found in high-temperature environments. Due to this fact, drilling for oil and gas recovery is limited in certain areas of the world where geothermal activity is high. This limitation poses a challenge for the energy sector, as it restricts access to valuable hydrocarbon resources. Conversely, the same geothermal heat that hinders oil and gas extraction can be harnessed for power generation, highlighting a need to establish power generation facilities in areas with significant geothermal deposits.

Different types of rock exhibit varying capabilities to store and conduct heat. The thermal conductivity of rock depends on its composition and the geological stratum it belongs to. For instance, igneous rock generally has low thermal conductivity, making it less suitable for efficient heat extraction. On the other hand, sedimentary rock tends to have higher thermal conductivity, followed by metamorphic rock, which falls somewhere in between. In sharp contrast, materials having excellent thermal conductivity like copper exhibit vastly superior thermal conductivity over igneous rock. This variability necessitates careful geological surveys to identify optimal sites and relatively large surface area exposure of the formation for geothermal projects. There is an urgent need to extract heat from rock formations to enable beneficial activities such as energy production. Efficient heat extraction can play a crucial role in meeting the world's growing energy demands while reducing reliance on fossil fuels. Moreover, it is essential to perform this extraction in an environmentally efficient manner to minimize the ecological impact and ensure the sustainability of geothermal projects.

Maximizing construction efficiency when establishing geothermal heat extraction systems is another critical need. Efficient construction practices can significantly reduce the costs and time associated with developing geothermal facilities, making the technology more accessible and economically viable. Innovations in drilling techniques, materials, and system designs are necessary to achieve these goals and support the widespread adoption of geothermal energy.

There is a need to provide an apparatus and methods that are easier to operate than conventional heat extraction apparatus and methods currently used.

There is a further need to provide apparatus and methods that do not have the drawbacks discussed above, such as the requirement to have large accessible surface area of geological stratum that may be rare in the everyday environment.

There is a still further need to reduce economic costs for power production in certain areas of the globe.

### SUMMARY

So that the manner in which the above recited features of the present disclosure can be understood in detail, a more particular description of the disclosure, briefly summarized below, may be had by reference to embodiments, some of which are illustrated in the drawings. It is to be noted that the drawings illustrate only typical embodiments of this disclosure and are; therefore, not to be considered limiting of its scope, for the disclosure may admit to other equally effective embodiments without specific recitation. Accordingly, the following summary provides just a few aspects of the description and should not be used to limit the described embodiments to a single concept.

In one example embodiment, a method for creating a closed loop geothermal system is disclosed. The method may comprise creating a first wellbore, the first wellbore having a first vertical section and a second section. The method may further comprise creating a second wellbore with a vertical section. The method may further comprise drilling at least one cross-lateral well from either the first wellbore or the second wellbore to a respective opposite well, the cross-lateral well intersecting both the first wellbore and the second wellbore.

In another example embodiment, a method for creating a closed loop geothermal system is disclosed. The method may comprise creating a first wellbore, the first wellbore having a first vertical section and a second lateral section. The method may further comprise creating a second wellbore with a vertical section and a second lateral section. The method may further comprise drilling at least one cross-lateral well from either the first wellbore second lateral section or the second wellbore lateral section to a respective opposite lateral section, the cross-lateral well intersecting both the first wellbore and the second wellbore.

In another example embodiment, a method to construct a closed loop geothermal system is disclosed. The method may comprise drilling a first well, the first wellbore having a first vertical section and a second lateral section. The method may further comprise drilling a second well with a first vertical section and a second lateral section. The method may further comprise drilling at least one cross-lateral well from either the first wellbore second lateral section or the second wellbore lateral section to a respective opposite lateral section, the cross-lateral well intersecting both the first wellbore and the second wellbore and wherein during the drilling process of the drilling of the first well and the second well, at least one of a common pit, generator bank, mud recovery system and cementing equipment system are used.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the drawings. It is to be noted; however, that the appended drawings illustrate only typical embodiments of this disclosure and are; therefore, not be considered limiting of its scope, for the disclosure may admit to other equally effective embodiments.

FIG. 1 is a graph of a well temperature log showing depth and temperature encountered at depth.

FIG. 2 shows extraction of heat Q_{extract} from a large rock volume.

FIG. 3 is a graph of different conventional construction techniques for world-wide projects for heat extraction.

FIG. 4 is a cross-section of different conventional construction heat extraction projects in Europe.

FIG. 5 is an illustration of phases for AGS well construction.

FIG. 6 is a graph of risks associated with enhanced geothermal systems (“EGS”) and advanced geothermal system (“AGS”) wellbores.

FIG. 7 is a graph of wellbore design and construction for AGS systems in one example embodiment of the disclosure.

FIG. 8 is a vertical cross-section of a drilling strategy (left) and optimized equipment layout (right) according to one example embodiment of the disclosure.

FIG. 9 is a side view and a top view of a well geometry in one example embodiment of the disclosure.

FIG. 10 illustrates possible wellbore geometries in example embodiments of the disclosure.

FIG. 11 illustrates different well geometries.

FIG. 12 is a graph of field settings for one example embodiment of the disclosure.

FIG. 13 is a cross-sectional view of loop geometry in example embodiments of the disclosure.

FIG. 14 is a cross-sectional view of injector well specifications in example embodiments of the disclosure.

FIG. 15 is a cross-sectional view of producer well specifications in example embodiments of the disclosure.

FIG. 16 is a cross-sectional view of lateral well specifications in one example embodiment of the disclosure.

FIG. 17 is a vertical cross-section of a drilling strategy for forming cross-lateral wells between non-vertical sections of a single wellbore as an injector and producer well, in one example embodiment of the disclosure

FIG. 18 illustrates possible wellbore geometries in example embodiments of the disclosure.

FIG. 19 is a flowchart of a method for establishing a closed loop geothermal system in one example embodiment of the disclosure.

To facilitate understanding, identical reference numerals have been used, where possible, to designate identical elements that are common to the figures (“FIGS”). It is contemplated that elements disclosed in one embodiment may be beneficially utilized on other embodiments without specific recitation.

### DETAILED DESCRIPTION

In the following, reference is made to embodiments of the disclosure. It should be understood; however, that the disclosure is not limited to specific described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments, and advantages are merely illustrative and are not considered elements or limitations of the claims except where explicitly recited in a claim. Likewise, reference to “the disclosure” shall not be construed as a generalization of inventive subject matter disclosed herein and should not be considered to be an element or limitation of the claims except where explicitly recited in a claim.

Although the terms first, second, third, etc., may be used herein to describe various elements, components, regions, layers and/or sections, these elements, components, regions, layers and/or sections should not be limited by these terms. These terms may be only used to distinguish one element, components, region, layer or section from another region, layer, or section. Terms such as “first”, “second”, and other numerical terms, when used herein, do not imply a sequence or order unless clearly indicated by the context. Thus, a first element, component, region, layer, or section discussed herein could be termed a second element, component, region, layer, or section without departing from the teachings of the example embodiments.

When an element or layer is referred to as being “on”, “engaged to”, “connected to”, or “coupled to” another element or layer, it may be directly on, engaged, connected, coupled to the other element or layer, or interleaving elements or layers may be present. In contrast, when an element is referred to as being “directly on”, “directly engaged to”, “directly connected to”, or “directly coupled to” another element or layer, there may be no interleaving elements or layers present. Other words used to describe the relationship between elements should be interpreted in a like fashion. As used herein, the term “and/or” includes any and all combinations of one or more of the associated listed terms.

Some embodiments will now be described with reference to the figures. Like elements in the various figures will be referenced with like numbers for consistency. In the following description, numerous details are set forth to provide an understanding of various embodiments and/or features. It will be understood; however, by those skilled in the art, that some embodiments may be practiced without many of these details, and that numerous variations or modifications from the described embodiments are possible. As used herein, the terms “above” and “below”, “up” and “down”, “upper” and “lower”, “upwardly” and “downwardly”, and other like terms indicating relative positions above or below a given point are used in this description to more clearly describe certain embodiments.

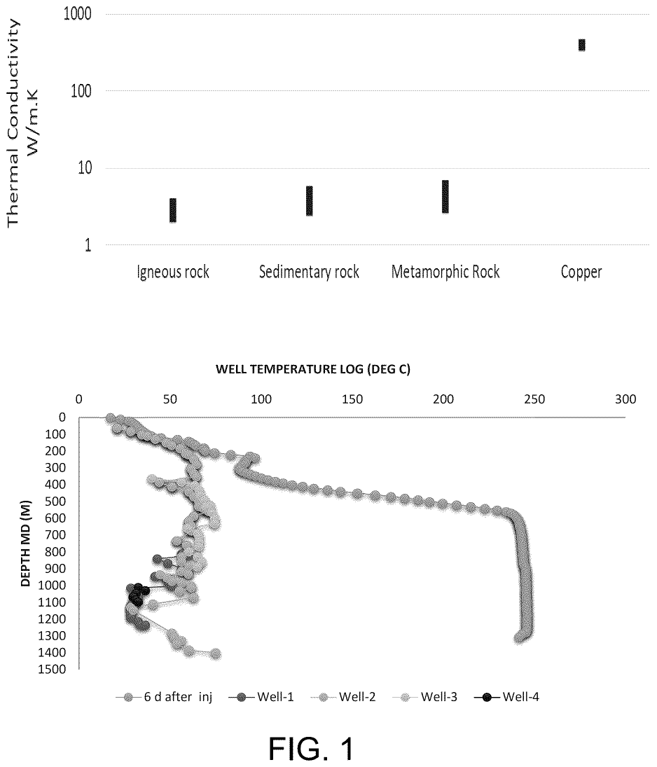

Referring to FIG. 1 (top) illustrates different thermal conductivities for different types of rock formations commonly found around the world. At the left, igneous rock formations have a relatively low ability to transmit thermal energy, while, progressing to the right, sedimentary, and metamorphic rocks are shown. For reference of a known effective thermal conductor, copper is shown to be approximately 50-100 times more thermally conductive than igneous, sedimentary, and metamorphic rock. As can be seen, areas that have igneous rock are generally not considered favorable to creation of EGS or AGS systems for heat extraction.

Further referring to FIG. 1 (bottom), a well temperature log showing temperature is illustrated. As can be seen, the deeper the wellbore goes, generally, the more elevated the temperature. In some applications; however, temperatures are much higher. This variability can be an advantage or a liability according to a geothermal system design. In the case of conventional geothermal heat extraction systems, higher temperatures are more beneficial as more heat is available to be extracted. As the wellbores approach the left side of the graph; however, the economics of heat extraction become more challenging. In these instances, geothermal systems may not be installed because the temperatures may be inadequate. As can be seen in the graph, many of the wells drilled in this area fall into this regime. Thus, as can be seen from the graph, the wellbore to the right may be successfully used for heat extraction, while the many wellbores to the left might not be chosen as candidates for heat extraction.

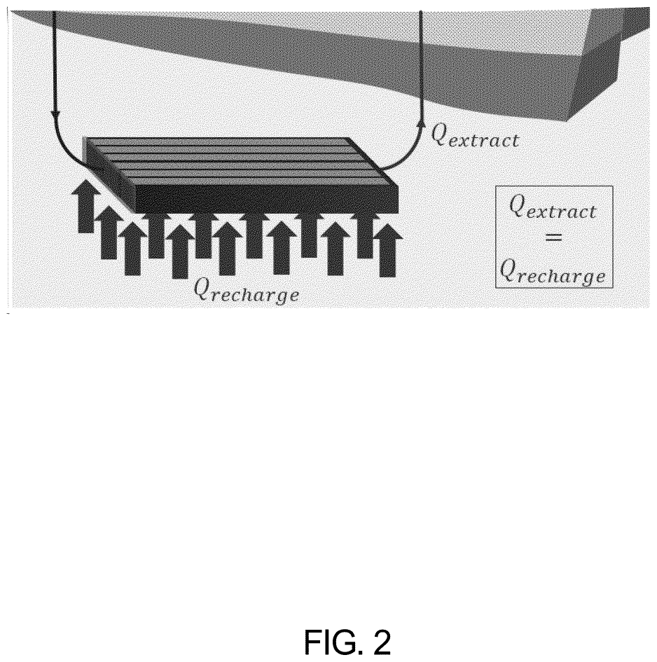

Extracting heat from a geological stratum is illustrated in FIG. 2. A fluid is injected at the left side of the figure and heat from the geological stratum is transferred to the fluid under the surface of the Earth. The amount of heat extracted, Q_{extract}, is equal to the amount of heat Q_{recharge} input into the fluid. As can be understood, the larger the amount of heat recharge, the faster the fluid may be pumped as the transfer gradient between the fluid pumped into the wellbore will be greater. Such systems illustrate the problems with conventional technologies in that large rock volumes are necessary as well as large heat exchange surfaces. When either the volume of rock is smaller or if the exchange surfaces are reduced the overall amount of heat recharge Q_{recharge} is reduced.

In formations with very high temperatures, drilling within these geological stratum can be problematic in itself. The high temperatures affect the drilling equipment and higher levels of maintenance is required. Thus, some geological stratum may require use of insulated equipment to establish viable wellbores. In extreme cases, the wellbores cannot be drilled at all. Thus, what initially looks like a promising well for geothermal exchange becomes problematic and not a good candidate for exploitation. As can be understood, temperatures that are not as elevated may be better alternatives, but if the amount of potential heat extracted is too low, the system may be uneconomical.

Aspects of the disclosure provide for proper characterization of the rock formations, thus leading to correct identification of economical candidates for heat extraction techniques. Identification of so called “Hot Dry Rock” may be accomplished as well as “Super Hot Rock” for focusing on new technologies for harvest of currently unavailable geological stratum.

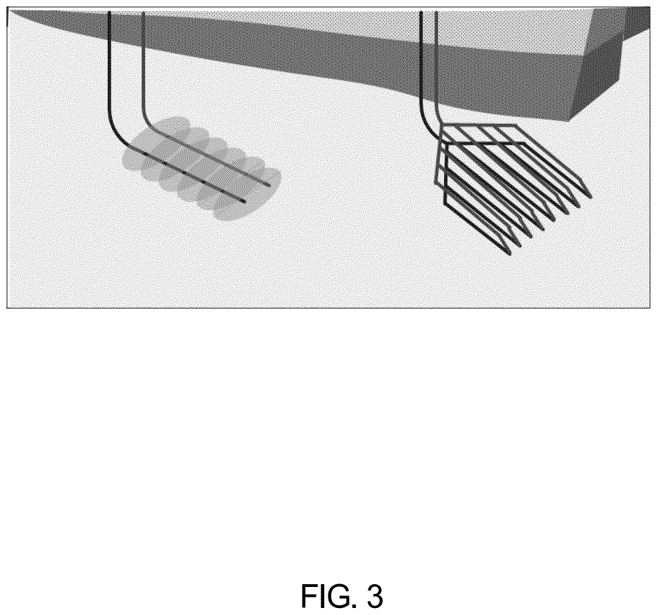

Referring to FIG. 3, an example of EGS and AGS systems are illustrated. In the left side of FIG. 3, the left most wellbore illustrates an EGS with an injection wellbore while the wellbore next to the injection portion is a recovery wellbore. The geological stratum between the injection and recovery wellbores is filled with fractured laterals. The fractured laterals may be natural or man-made. As the fluid is pumped down the injection wellbore, it travels through the rock matrix to the recovery wellbore. During the transition from the injection wellbore to the recovery wellbore, heat is transferred to the fluid, thus the fluid is then capable of being used in a power generation process. Problems exist; however, in such configurations. The rock matrix is not always homogeneous and various zones of different material may exist. The rock matrix may go from a brittle zone to a ductile zone. In such zones, the permeability may be affected and the fluid transfer from the injection wellbore to the recovery wellbore may be problematic. Furthermore, erosion of pathways through the formation may reduce heat extraction over time. Moreover, fluid loss to the formation or the intrusion of other formation fluids into the wellbores may be possible, such that the composition of the heat exchange fluid within the wellbores is more difficult to control. Scaling and/or blockage of some pathways may occur with such open loop systems.

Further referring to FIG. 3 (right side), an AGS system is illustrated with insulated pipes in portions of the wellbores. The injection side (left most wellbore) is connected to the recovery side (right side wellbore). In this embodiment, many drilled laterals are required for heat recovery. The capital cost of such applications often reduces the economic returns.

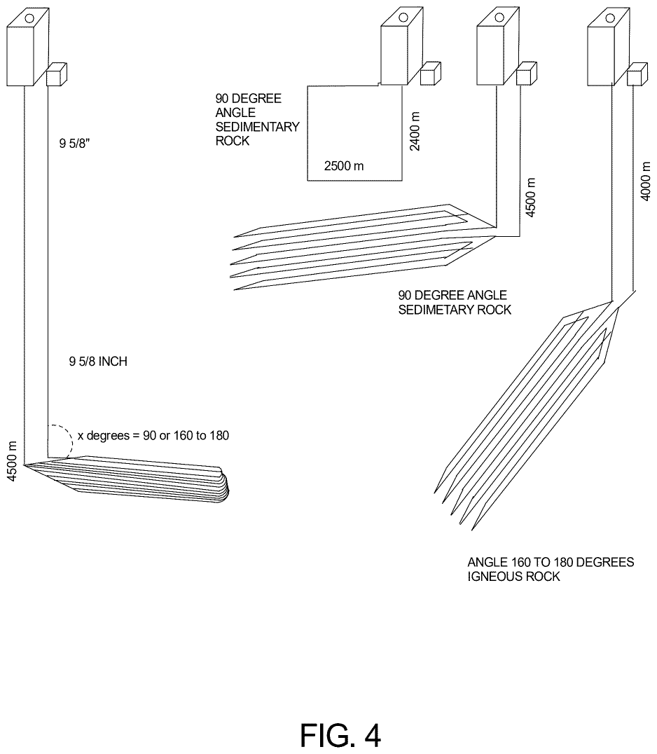

FIG. 4 illustrates a thermosiphon configuration where pumping is optional. No hydraulic fracturing is necessary and operating costs are vastly superior to the embodiments illustrated in FIG. 3 for EGS. In these embodiments, “radiator” sections are placed at the bottom of the respective wellbores. In some embodiments, twelve legs are contained in the vertical section with 24 legs in total. In such systems, no GHGs or carbon dioxide is used. Some conventional projects provide for closed systems with no need for a permeable aquifer. Minimal continual water use is planned with no brine production. The costs for such systems are 80 percent less than traditional geothermal systems with low thermal output risk or uncertainty. Project cycles times may vary from 3 to 5 years and operate on a baseload or dispatchable basis. Different dogleg angles or configurations may be provided. In some embodiments, a closed loop system with a 2500 m bottom and 2400 m sides are provided in a conventional system placed in sedimentary rock. In other embodiments, a 4500 m down leg is provided with an extended radiator section emanating from the down-leg system. This type of system is contemplated in sedimentary rock. In a different configuration, a 4000 m down leg is provided with a 60 to 180 degree angle from the down leg. This configuration is anticipated to be placed in igneous rock. In some embodiments, once each leg between the original wellbores is drilled, a tubular may be run through the legs. Each tubular through the legs may reduce or eliminate direct contact between the water within the leg and the rock, thereby reducing the risks of erosion or contamination of the water with minerals from the formation. In some embodiments, the tubulars may be run into the legs with a rotary rig, a coiled tubing rig, a workover unit, or a snubbing unit. In some embodiments, the coiled tubing string may be run to the bottom of the desired wellbore, then cut and released in place. These tubulars or coil tubing sections positioned in the legs may be referred to herein as “liners.” In some embodiments, measures may be taken to reduce or eliminate fluid flow through the annual space between the liners and the rock face of the formation. For example, packers and/or cement may be used. In some embodiments without liners, chemical products may be used to reduce or eliminate cross-contamination of the fluid through the leg with fluid or material of the formation and may reduce or eliminate erosion of the formation. As will be understood, different phases of projects may be undertaken. For example, a first phase of a 8 MWth capacity may be planned with subsequent phases of 200 Mwe. In some embodiments, a first power of 2 MWe may be constructed with anticipated costs of 252/MWh Euros. In fully operational systems planned for the future, supply district heating systems for multiple towns (2) may be provided.

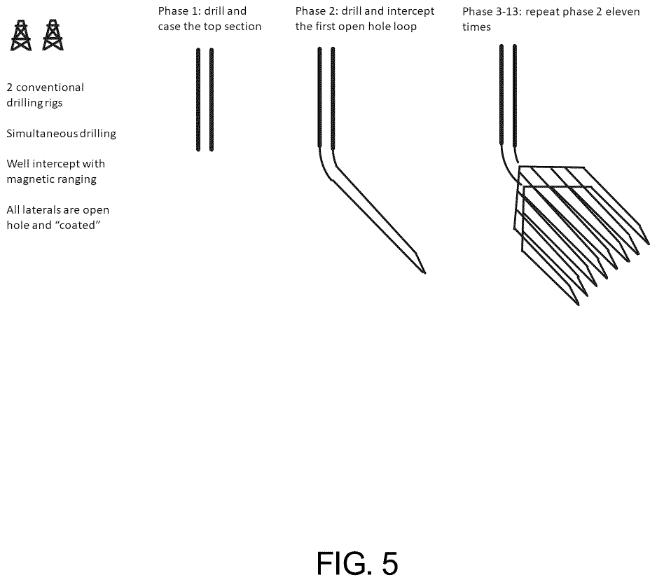

Referring to FIG. 5, two conventional drill rigs are used to create the wellbores needed for the formation of the system shown in FIG. 4. Simultaneous drilling is conducted. In order to provide for proper interception of different wellbores, magnetic ranging is performed during the drilling process. In the first phase, the top sections of the wells are drilled and cased. In the second phase the drilled sections are increased and intercepted, as illustrated. In each subsequent phase, a process similar to phase 2 is conducted to produce the radiator sections of the AGS system.

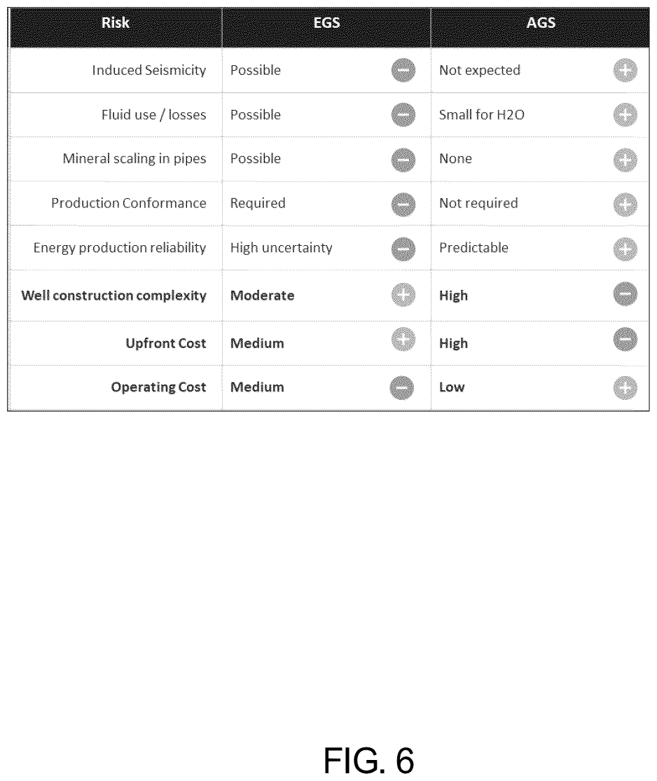

Aspects of the disclosure provide a remedy for economic improvements with AGS. Referring to FIG. 6, a listing of the needs and advantages and disadvantages of the conventional EGS and AGS systems is provided. For EGS systems, possible risks include induced seismicity, fluid losses, and mineral scaling in pipes. EGS systems may have a required production conformance of the fluid flow and/or energy production for steady-state operations, and may face uncertain energy production reliability due to erosion, scaling, and potential blockages. Furthermore, pumps for EGS systems may increase operating costs. In contrast, an AGS is less likely to induce seismicity, utilizes less water, and does not produce mineral scaling within piping compared to an EGS. An AGS utilizes a closed loop flow such that production performance is not required. Moreover, an AGS is designed to have highly predictable and reliable energy production. Due to thermosiphon effects, the operating cost for AGS may be less than for EGS with a similar energy production. However, the complexity and upfront cost of AGS with conventional drilling schemes, such as shown in FIG. 4, may be very high, thereby increasing the risks for AGS systems. It is desirable to produce the AGS benefits at lower complexity and upfront costs.

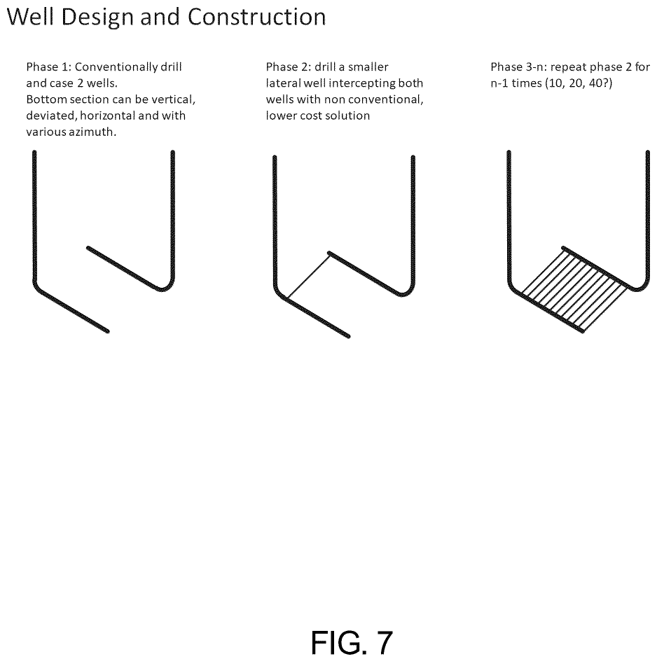

Referring to FIG. 7, an example embodiment for well design and construction for an AGS system according to the disclosure is presented. At the left, in phase 1, two vertical wellbores are drilled near one another. At the bottom of the two wellbores created, a set of parallel laterals are created, thus creating “L” shaped wellbores. In such a configuration, a single drill rig may be used serially, thus saving on overall construction costs. In other embodiments, where construction is to be established quickly, two drill rigs may be simultaneously used to create the wellbores. In phase 2, located in the center of FIG. 7, a smaller lateral well that intercepts both wells is created, such as with coiled tubing. In some embodiments, the target reservoir section may be left un-cased to facilitate open-hole sidetracks, such as sidetracks with coil tubing. The uncased sections may reduce or eliminate trips to run and/or retrieve equipment used to create the sidetrack in a cased hole. The uncased sections may include but are not limited to open hole sections or bare foot sections. Equipment facilitating sidetracks may include but are not limited to whipstocks and cement plugs. The cost and time associated with such sidetrack equipment may be avoided through the use of coiled tubing and uncased sections to form the cross-lateral wells between the injector and producer wellbores. Phase 2 creates a connection between the two wellbores in an economical fashion. As illustrated in Phase 3, the creation of a lateral is repeated as many times as needed. With the advent of accurate horizontal drilling, vast areas may be established to act as the “radiator” section in an AGS system as drastically reduced cost. Expansive magnetic ranging may be omitted in some instances where the injection and recovery vertical sections are located at relatively close range. Moreover, in some instances, the use of different size wellbore construction for the wellbore laterals allows for easier intercept with the larger base wellbores. Moreover, the smaller wellbore laterals may facilitate improved steering to form the laterals as sidetracks from the larger wellbores.

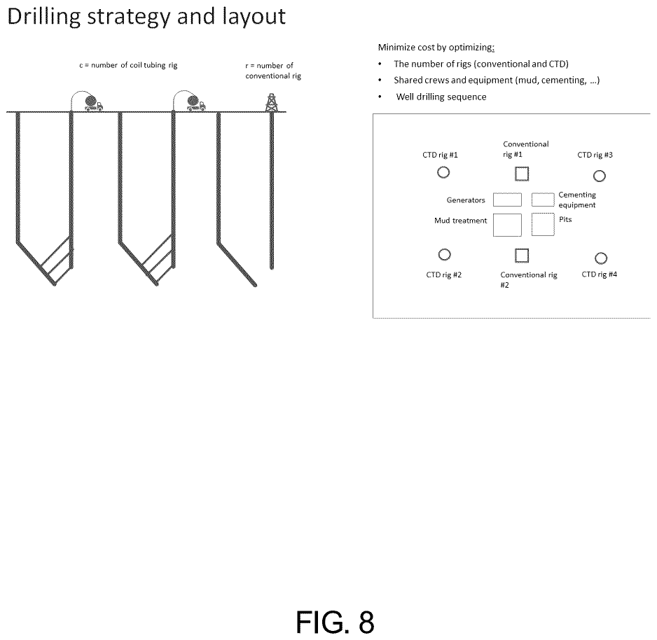

Referring to FIG. 8, a vertical cross-section of a proposed embodiment of the disclosure is presented. In this embodiment, two separate wellbores are illustrated. The left most wellbore has both vertical and non-vertical (e.g., tangential, deviated) components. The right most wellbore has only a vertical component. After formation of the primary wellbores, a coiled tubing rig may be used with an existing wellbore to allow for flexibility in drilling the lateral wells to the other existing wellbore. The coiled tubing may be smaller and more flexible than traditional drill pipe and uses fewer connections. As will be understood, a number of runs for the coiled tubing rig may be provided, thereby creating a complex geometry of wellbores that increases the overall surface area of the “radiator” section of an AGS system well. As illustrated, a conventional rig may be used to quickly drill the main sections of the radiator system, and the coil tubing rig may be used to drill the lateral wells.

Further referring to FIG. 8 (right side), a plot plan for expected equipment layout for construction of the wellbore layout is illustrated. In the plot plan, multiple coiled tubing rigs and one or more conventional drill rigs are used to create the overall system. Auxiliary and support systems for coiled tubing rigs and/or conventional drill rigs may be shared and arranged to be accessible for multiple drill sites within a geothermal field. To increase economy, a universal mud treatment center may be shared among rigs to drive down the overall costs. A common bank of generators may also be used to provide power for the needs of drilling. Similar to the other systems, a centralized cementing equipment portfolio and waste pits may be used, as well as accommodations for crew and maintenance facilities. Operating multiple standardized drilling units (e.g., rotary units, coiled tubing units) may also be beneficial due to economies of scale.

Adding to the economic benefit of the systems disclosed, crews may be shared among the different drilling systems. Additionally, given the relatively low operational risks vis-à-vis operations that drill through fluid bearing formations, particularly non-hydrocarbon bearing formations, automation of the drilling process may be particularly beneficial. As labor costs can be a very large percentage of overall costs, such sharing among drilling systems provides clear advantages over conventional technologies.

As will be understood, the laterals between the primary wellbores may be completed/constructed using different drilling technologies. These may include, but not be limited to, light conventional rotary drilling rigs (with or without hammer), coiled tubing drilling, wireline drilling, plasma drilling, laser drilling, EM drilling, and side core drilling. The one or more conventional rigs may be used to drill a first well (e.g., injector) with a vertical section and a second well (e.g., producer). The one or more conventional rigs may also be used to case one or both of the first well and the second well. The one or more coiled tubing rigs may then be used to drill the lateral wells between the first well and the second well. In some embodiments, the total length drilled by conventional rigs may be between 5 km to 40 km, between 10 km to 30 km, or approximately 20 km. Although each lateral well may be shorter than one or both of the first well and the second well, embodiments described herein may have between 5 to 40 lateral wells such that the total length drilled by coiled tubing rigs may be between 5 to 50 km, between 10 to 40 km, or between 20 to 30 km. That is, the total length of the lateral wells drilled by the coiled tubing rig between the first well and the second well may be between 25 percent to 1000 percent the total length of the first well and the second well drilled by one or more conventional rigs.

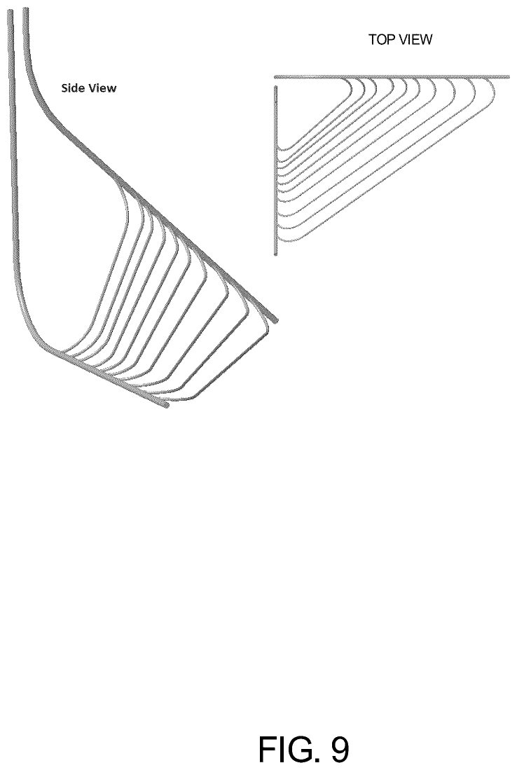

Referring to FIG. 9, different geometries for well systems are illustrated. In these embodiments, seven-inch main wells are provided with smaller lateral wells of between 50 to 500 feet. These smaller lateral wells may range, in non-limiting embodiments, between one to five and a half inches in diameter. Connections between different wellbores may be performed, in some embodiments, through coiled tubing apparatus. In embodiments, as illustrated, the overall construction may be quite complex. A top view of such a configuration is illustrated at the right side of FIG. 9.

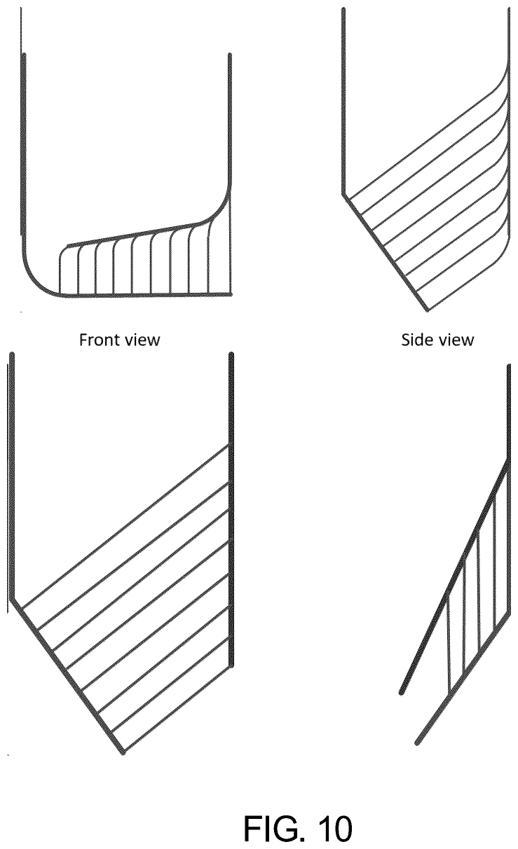

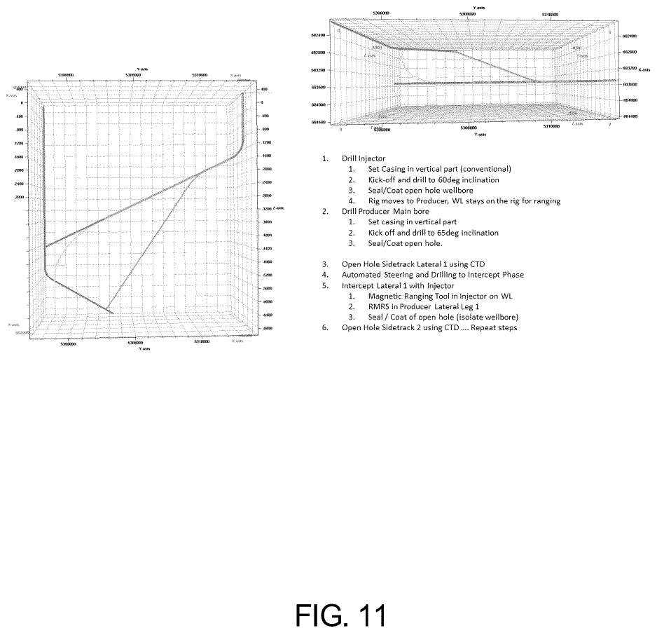

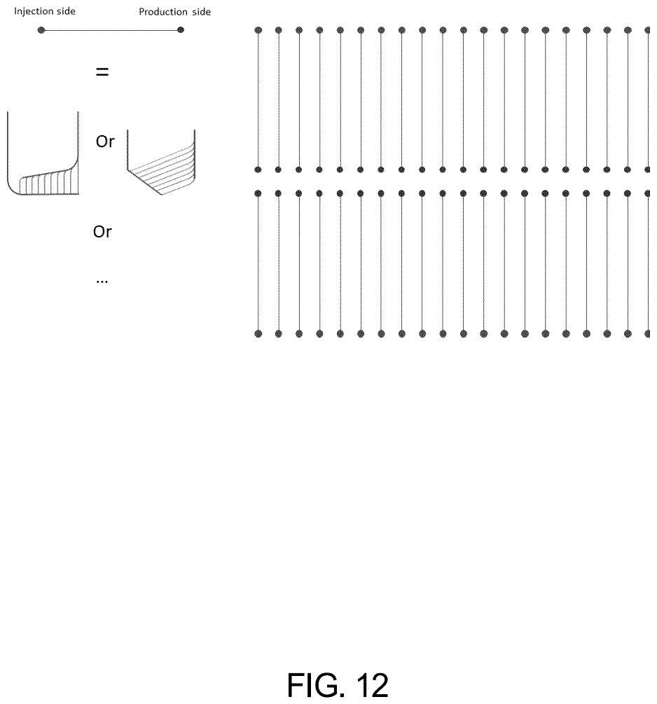

Referring to FIGS. 10 and 11 different types of possible well geometries are illustrated. Other variations of wellbore geometries are possible. In some embodiments, one well may be formed with a first vertical section and a second non-vertical section (e.g., horizontal section), and cross-lateral wells may be formed to connect the first vertical section and the second non-vertical section. The first vertical section may have a greater diameter than the second non-vertical section, such as between 25 to 50 percent larger. The diameters of the cross-lateral wells may be less than the second non-vertical section, such as between 25 to 50 percent smaller. For example, the first vertical section may have a 10.75 inch cased diameter, the second non-vertical section may have a 7 inch cased diameter, and the cross-lateral wells may have coiled tubing between 1 to 3 inch diameter or more. Referring to FIG. 12, a graph of field settings are illustrated. As illustrated, the injection sites are located at the top points and bottom points of the graphs. Recovery or production sites for heated fluid are presented between the injection sites. As illustrated in the left most section of FIG. 12, different configurations for vertical overlayment or twinned wells may be used. For example, multiple pairs of injection side wells (blue) and production side wells (red) may be formed with a plurality of lateral wells as shown in FIGS. 8-11, and each pair may be arranged within a geothermal production field as shown in FIG. 12. The plot plan illustrated with FIG. 8 may facilitate the economical use of shared equipment and support systems among a few conventional rigs and lateral drilling rigs (e.g., coiled tubing rigs). In some embodiments, between 20 to 100 doublets (e.g., pairs of injector and producer wells with adjacent producer wells) may be formed in a geothermal production field. The spacing between adjacent producer wells may be between 50 to 500 meters, and the lateral spacing between doublets may be between 150 to 500 meters. Dense arrangements of doublets with multiple lateral wells described herein may facilitate improved heat extraction from closed loop systems within the geothermal production field at reduced costs despite the low thermal conductivity of the formation.

In some embodiments, coiled tubing drilling may be used to drill the cross lateral wells between the second-non-vertical well of the injector well, and the second-non-vertical well of the producer well. Depending on the trajectory of the cross lateral wells, the coiled tubing may enter into the injector well and drill the cross lateral wells to intercept with the producer well. Alternatively, the coiled tubing may enter into the producer well, drill the cross lateral wells, and intercept with the injector well. In yet another embodiment, coiled tubing drilling may do open hole side tracking technique to drill the cross lateral wells. Depending on the type of formation, the cross lateral wells may be cased, or they may not be cased. In one embodiment, when the cross lateral wells are to be cased, the second-non-vertical well of both the injector well and the producer wells may be cased with the casings have the preset slots aligned with the cross lateral wells. To case the cross lateral wells, a coiled tubing may be run with a resettable whipstock. The whipstock is set right below the target cross lateral in the second non-vertical well of either the injector or the producer wells. The whipstock guides the coiled tubing to enter into the targeted cross lateral, continue to run the coiled tubing into the cross lateral until it reaches the other second non-vertical well. The coiled tubing is then cut right above the whipstock. Afterward, the whipstock is released and set right below another cross lateral well. This procedure can be repeated until all cross laterals are cased with coiled tubing.

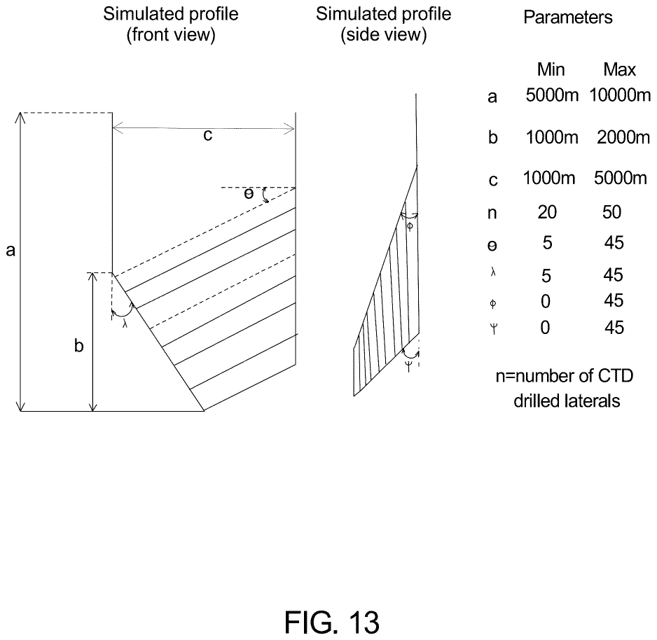

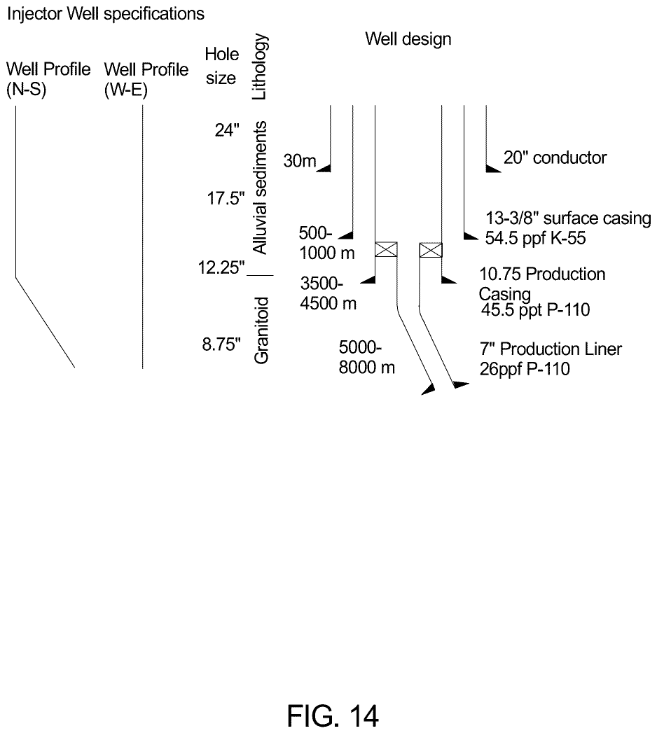

Referring to FIG. 13, example loop geometries are illustrated. In the left most section, a simulated profile (front view) is illustrated. In the middle section, a simulated side view is provided. In the right section, example values (parameters) for the angles and distances are disclosed. Other values may be used. Referring to FIG. 14, injector well specifications are provided. In the left most section, a north-south well profile is provided. In the center section, a west-east well profile is illustrated. In the center right section, various hole sizes for the right most well design are provided. As illustrated in the right most well design, a 30 meter outer casing of a 20 inch conductor is provided with progressively narrower interior casing structures. The second from the outside surface casing extends for 500 to 1000 meters with 13⅜ inch casing. A 10¾ inch production casing is placed within the surface casing extending for 3500 to 4500 meters. An inner 7 inch production liner is provided for lengths of 5000 to 8000 meters.

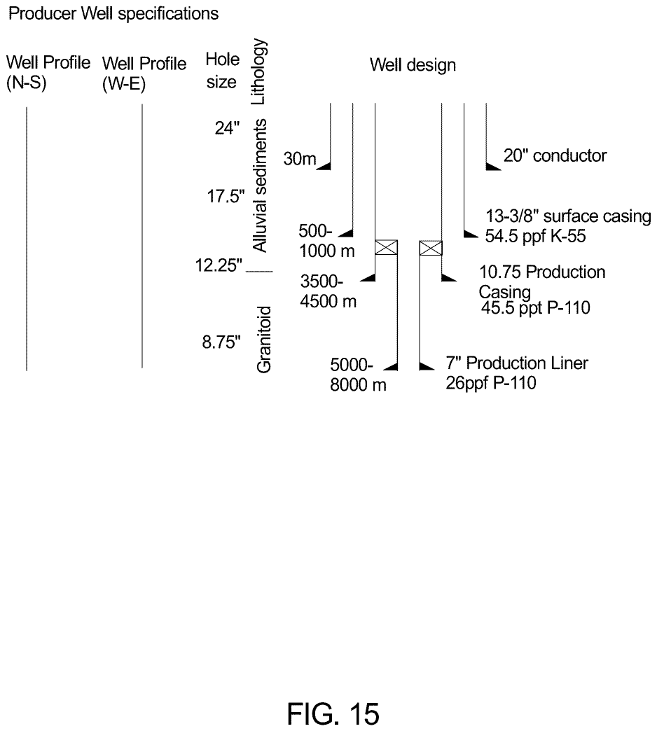

Referring to FIG. 15, producer well specifications are provided. In the left most section, a north-south well profile is provided. In the center section, a west-east well profile is illustrated. In the center right section, various hole sizes for the right most well design are provided. As illustrated in the right most well design, a 30 meter outer casing of a 20 inch conductor is provided with progressively narrower interior casing structures. The second from the outside surface casing extends for 500 to 1000 meters with 13⅜ casing. A 10¾ inch production casing is placed within the surface casing extending for 3500 to 4500 meters. An inner 7 inch production liner is provided for lengths of 5000 to 8000 meters.

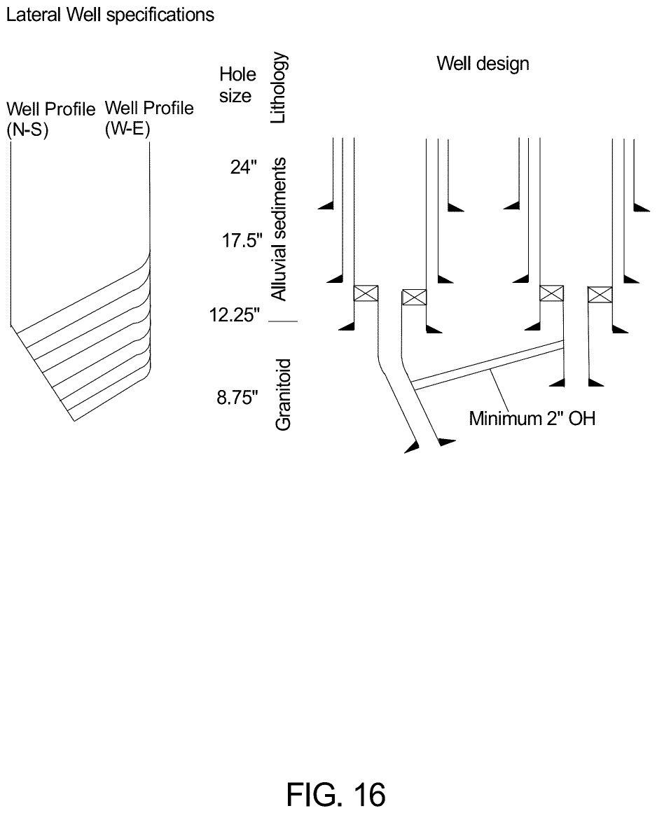

Referring to FIG. 16, lateral well specifications are provided. In the left most section, a plotted view of the wellbores is provided. In the center section, various hole sizes for the right most well design are provided. In this embodiment, a minimum 2 inch well is provided between the two illustrated wellbores.

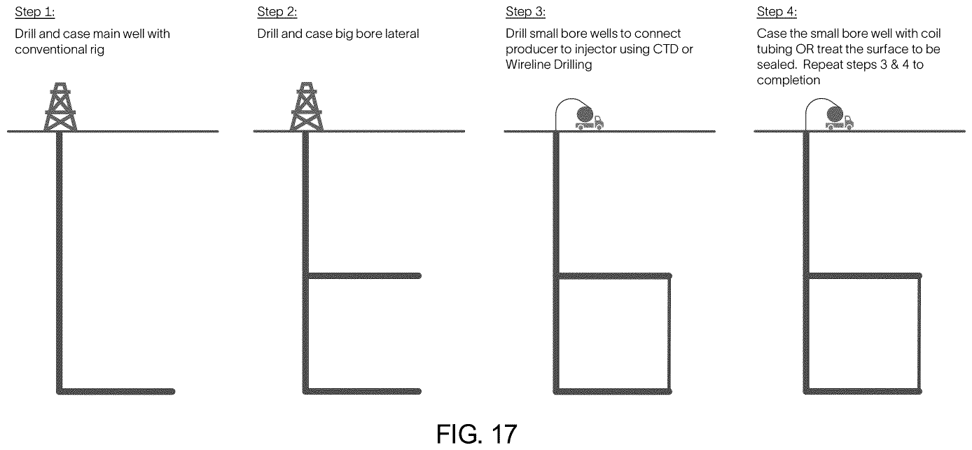

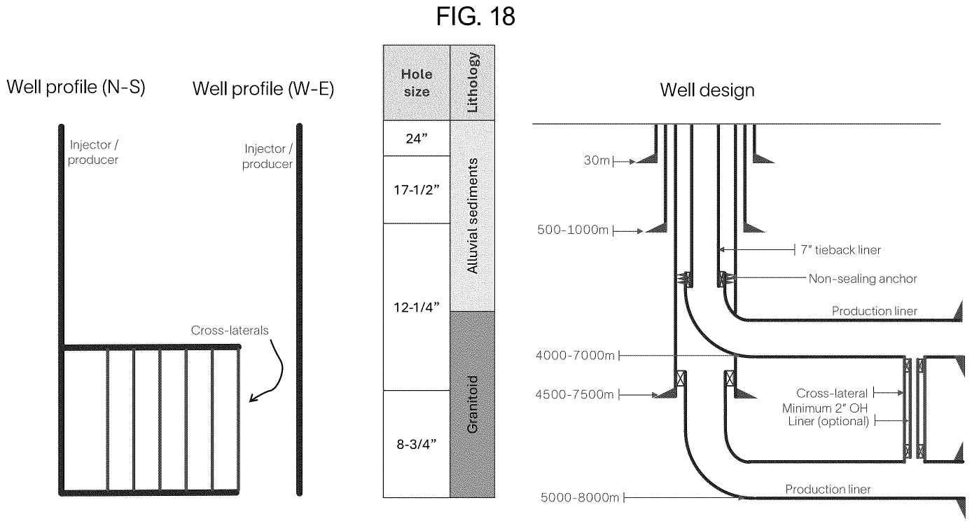

Referring to FIG. 17, one well may be formed with a first vertical section, a second non-vertical section (e.g., first horizontal section) extending from the first vertical section at a first depth, and a third non-vertical section (e.g., second horizontal section) extending from the first vertical section at a second depth intermediate to the first depth and the surface. One or both of the second non-vertical section and the third non-vertical section may be horizontals, inclined, deviated wells, or any profile discussed above. A conventional rig may be used to form the first vertical section, the second non-vertical section, and the third non-vertical section. The first vertical section, the second non-vertical section, and the third non-vertical section may be cased and/or lined. One or more cross-lateral wells may then be formed smaller diameter lateral wells between the second non-vertical section and the third non-vertical section. For example, a coil tubing rig and/or wireline drilling may be used to form the cross-lateral wells, as shown in FIG. 17. The small bore wells between the second and third non-vertical sections may be vertical, slanted, deviated, or any profile. In some embodiments, the small bore wells are cased, lined, or treated to seal a surface of the formation. Multiple cross-lateral wells may be formed (and optionally lined) in this manner. For example, 5, 10, 15, or 20 cross-lateral wells may be formed to fluidly connect the second non-vertical section with the third non-vertical section. Whereas the vertical section may have a diameter greater than 7″, 8″, 10″, 12″, 16″, 20″, or 24″, the second and third non-vertical sections may have a diameter between 3″ to 10″, and the cross-lateral wells may have a diameter between 1″ to 5″, such as 2″ or 3″. The upper lateral from the injector/producer wellbore may have a tieback liner that permits flow around the upper liner to the bottom lateral for circulation. Referring to FIG. 18, lateral well specifications are provided. In the left most section, a plotted view of the wellbores is provided. In the center section, various hole sizes for the right most well design are provided. In this embodiment, a minimum 2 inch well is provided between the two illustrated wellbores. During operation, a geothermal fluid may be directed through the first vertical section to the bottom non-vertical section, up through the cross-lateral wells, and to the surface via the upper non-vertical section and the first vertical section.

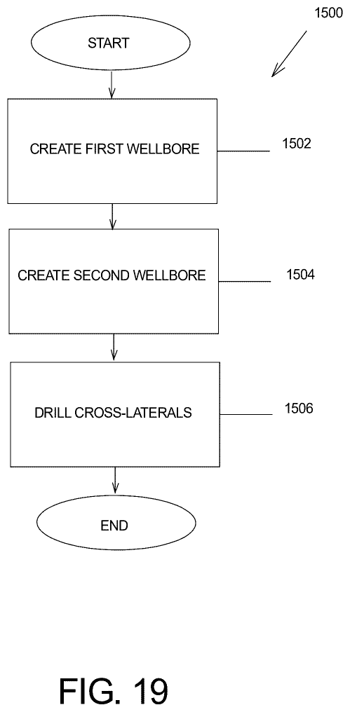

Referring to FIG. 19, a method 1500 for creating a closed loop geothermal system is illustrated. The method 1500 may comprise, at 1502, creating a first wellbore, the first wellbore having a first vertical section and a second section. The method may further comprise, at 1504, creating a second wellbore with a vertical section. The method may further comprise, at 1506, drilling at least one cross-lateral well from either the first wellbore or the second wellbore to a respective opposite well, the cross-lateral well intersecting both the first wellbore and the second wellbore. The cross-lateral wells may be formed with coiled tubing drilling, wireline drilling, plasma drilling, laser drilling, EM drilling, and side core drilling. At 1508, the method may also provide for running a liner, packer, cement, treatment or other means to reduce geothermal fluid interaction directly with the formation.

Example embodiments of the disclosure are presented. The example embodiments illustrated should not be considered limiting of the disclosure. In one example embodiment, a method for creating a closed loop geothermal system is disclosed. The method may comprise creating a first wellbore, the first wellbore having a first vertical section and a second section. The method may further comprise creating a second wellbore with a first vertical section. The method may further comprise drilling at least one cross-lateral well from either the first wellbore or the second wellbore to a respective opposite well, the cross-lateral well intersecting both the first wellbore and the second wellbore.

In another example embodiment, the method may be performed wherein the second section has both a vertical and a horizontal component.

In another example embodiment, the method may be performed wherein the second section has only a horizontal component.

In another example embodiment, the method may be performed wherein each of the cross-lateral wells is created by a coiled tubing drill rig.

In another example embodiment, the method may be performed wherein the first wellbore and the second wellbore have at least one portion that is vertically stacked.

In another example embodiment, the method may be performed wherein at least one portion of a vertical section of the first well and the second well are cased.

In another example embodiment, the method may be performed wherein each of the at least one cross-lateral wells has a diameter that is smaller than a diameter of the first wellbore and the second wellbore.

In another example embodiment, a method for creating a closed loop geothermal system is disclosed. The method may comprise creating a first wellbore, the first wellbore having a first vertical section and a second lateral section. The method may further comprise creating a second wellbore with a first vertical section and a second lateral section. The method may further comprise drilling at least one cross-lateral well from either the first wellbore second lateral section or the second wellbore lateral section to a respective opposite lateral section, the cross-lateral well intersecting both the first wellbore and the second wellbore.

In another example embodiment, the method may be performed wherein each of the cross-lateral wells is created by a coiled tubing drill rig.

In another example embodiment, the method may be performed wherein each of the at least one cross-lateral wells has a diameter that is smaller than a diameter of the first wellbore and the second wellbore.

In another example embodiment, the method may be performed wherein the first wellbore is created by a rotary drilling rig.

In another example embodiment, the method may be performed wherein the second wellbore is created by a rotary drilling rig.

In another example embodiment, a method to construct a closed loop geothermal system is disclosed. The method may comprise drilling a first well, the first wellbore having a first vertical section and a second lateral section. The method may further comprise drilling a second well with a vertical section and a second lateral section. The method may further comprise drilling at least one cross-lateral well from either the first wellbore second lateral section or the second wellbore lateral section to a respective opposite lateral section, the cross-lateral well intersecting both the first wellbore and the second wellbore and wherein during the drilling process of the drilling of the first well and the second well, at least one of a common pit, generator bank, mud recovery system and cementing equipment system are used.

In another example embodiment, the method may be performed wherein each of the cross-lateral wells is created by a coiled tubing drill rig.

In another example embodiment, the method may be performed wherein each of the at least one cross-lateral wells has a diameter that is smaller than a diameter of the first wellbore and the second wellbore.

In another example embodiment, the method may be performed wherein the first wellbore is created by a rotary drilling rig.

In another example embodiment, the method may be performed wherein the second wellbore is created by a rotary drilling rig.

In another example embodiment, the method may be performed wherein construction of the closed loop system is performed through remotely controlled drilling operations.

In another example embodiment, the method may be performed wherein the system is created in one of igneous, sedimentary and metamorphic rock.

In another example embodiment, the method may be performed wherein the at least one cross-lateral well is at least forty cross-lateral wells.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may be varied in many ways. Such variations are not to be regarded as a departure from the disclosure, and all such modifications are intended to be included within the scope of the disclosure.

While embodiments have been described herein, those skilled in the art, having benefit of this disclosure, will appreciate that other embodiments are envisioned that do not depart from the inventive scope. Accordingly, the scope of the present claims or any subsequent claims shall not be unduly limited by the description of the embodiments described herein.

What is claimed is:

1. A method for creating a closed loop geothermal system, comprising:
creating a first wellbore with a rotary rig, the first wellbore having a first vertical section and a second section;
creating a second wellbore with the rotary rig, the second wellbore having a second vertical section; and
drilling at least one cross-lateral well from either the first wellbore or the second wellbore to a respective opposite well, the cross-lateral well drilled with a second rig different than the rotary rig and intersecting both the first wellbore and the second wellbore.

2. The method according to claim 1, wherein the second section of the first wellbore has both a vertical component and a horizontal component.

3. The method according to claim 1, wherein the second section of the first wellbore has only a horizontal component.

4. The method according to claim 1, wherein the second rig comprises a coiled tubing drill rig.

5. The method according to claim 1, wherein at least a first portion of a vertical section of the first well and a second portion of the second well are cased.

6. The method according to claim 1, wherein each of the at least one cross-lateral wells has a cross-lateral diameter that is smaller than a first wellbore diameter of the second section of the first wellbore, and the cross-lateral diameter is smaller than a second wellbore diameter the second wellbore.

7. The method according to claim 1, comprising treating the cross-lateral wells to isolate a geothermal fluid from a formation around the cross-lateral well, wherein treating comprises adding chemical treatments, mechanical barriers, or any combination thereof.

8. A method for creating a closed loop geothermal system, comprising:
creating a first wellbore, the first wellbore having a first vertical section and a first lateral section;
creating a second wellbore with a second vertical section and a second lateral section; and
drilling at least one cross-lateral well from either the first lateral section or the second lateral section to a respective opposite lateral section using a coiled tubing drill rig, the cross-lateral well intersecting both the first wellbore and the second wellbore.

9. The method according to claim 8, wherein creating the first wellbore comprises using a rotary rig, and creating the second wellbore comprises using the rotary rig.

10. The method according to claim 8, comprising sidetracking through an uncased section of either the first lateral section or the second lateral section without a whipstock and without a cement plug.

11. The method according to claim 8, wherein each of the at least one cross-lateral wells has a lateral diameter that is smaller than a primary diameter of the first vertical section and the second vertical section.

12. The method according to claim 11, wherein the lateral diameter is less than 35 percent of the primary diameter.

13. The method according to claim 8, wherein creating the first wellbore comprises drilling with a rotary drilling rig.

14. A method to construct a closed loop geothermal system, comprising:
drilling a first well, the first wellbore having a first vertical section and a first lateral section;
drilling a second well with a second vertical section and a second lateral section; and
drilling at least one cross-lateral well from either the first lateral section or the second lateral section to a respective opposite lateral section, the cross-lateral well intersecting both the first wellbore and the second wellbore and wherein during the drilling process of the drilling of the first well and the second well, at least one of a common pit, generator bank, mud recovery system and cementing equipment system are used.

15. The method according to claim 14, wherein each of the cross-lateral wells is created by a coiled tubing drill rig.

16. The method according to claim 14, wherein each of the at least one cross-lateral wells has a lateral diameter that is smaller than a primary diameter of the first vertical section and the second vertical section.

17. The method according to claim 16, wherein the lateral diameter is less than 35 percent of the primary diameter.

18. The method according to claim 14, wherein the first wellbore and the second wellbore are created by a rotary drilling rig.

19. The method according to claim 14, wherein each of the cross-lateral wells is created by one of wireline drilling, plasma drilling, laser drilling, electromagnetic (EM) drilling, a coiled tubing drill, and side core drilling.

20. The method according to claim 14, wherein the system is created in one of igneous, sedimentary and metamorphic rock.
